(19) United States
(12) Patent Application Publication
(10) Pub. No.: US 2012/0280030 A1
(43) Pub. Date: Nov. 8, 2012

(54) COMMODITY INFORMATION REGISTRATION SYSTEM

(75) Inventor: Manabu Hashimoto, Osaka (JP)

(73) Assignee: SHARP KABUSHIKI KAISHA, Osaka (JP)

(21) Appl. No.: 13/415,484

(22) Filed: Mar. 8, 2012

(30) Foreign Application Priority Data
Mar. 10, 2011 (JP) 2011-053045

(51) Int. Cl. G06Q 90/00

(52) U.S. Cl. 235/375

(57) ABSTRACT

A commodity information registration system including a first terminal for inputting commodity information and a second terminal for performing a checkout process of a purchase. The first terminal has a bar-code input unit for reading barcodes including information having commodity specifying information and a code generating unit for creating a two-dimensional code including the commodity specifying information. The second terminal includes: a code input unit for reading the two-dimensional code so as to acquire the commodity specifying information; and a calculating unit for determining sales proceeds for each purchase and a total amount of all purchases in one transaction by using the commodity specifying information. The second terminal also stores sales data including the sales proceeds for each purchase in one transaction.

### CROSS-REFERENCE TO RELATED APPLICATION

This application is related to Japanese Patent Application No. 2011-053045 filed on Mar. 10, 2011, whose priority is claimed and the disclosure of which incorporated by reference in its entirety.

### BACKGROUND OF THE INVENTION

1. Field of the Invention

The present invention relates to a commodity information registration system, and more particularly to a commodity information registration system provided with a registration terminal by which a customer can register a purchase in a convenience store or a supermarket.

2. Description of the Background Art

In recent years, a convenience store or a supermarket utilizes a POS system that inputs information of a purchase, and manages sales and checkout.

In a store utilizing the POS system, plural checkout counters are arranged, and a cashier of the store uses a POS terminal for unifying the management of an input of commodity information, a checkout, and a delivery of charges. However, a waiting line of customers is formed at peak times.

Various POS systems have been proposed in order to reduce a number of cashiers and overcome the problem of the waiting time of customers. A so-called self-checkout by which a customer inputs information of his/her purchase is one of these systems.

Examples of utilization form of the POS system utilizing the self-checkout will be described below.

### Conventional Utilization Form 1

It is supposed that a self-checkout terminal by which a customer inputs purchase information, a main server that manages sales, and a POS terminal that manages checkout are connected to one another through network.
(1) A customer personally utilizes the self-checkout terminal for inputting the information of his/her purchase. In this case, the customer makes an operation of reading a bar-code attached to a commodity, whereby a commodity code and quantity of the purchase are inputted, and a total purchase amount is calculated.
(2) On the self-checkout terminal, the inputted commodity information (commodity code, quantity) and the total purchase amount are printed on a receipt as character information. In this case, a receipt number is also printed.
(3) The self-checkout terminal is connected to a main server of a store through network such as LAN. Therefore, print information including the inputted commodity information and the receipt number is transmitted to the main server.

With this, the main server stores the information (purchase information) of each commodity bought by the customer.
(4) Then, the customer goes to the POS terminal operated by a cashier of the store with the printed receipt and the purchase, and delivers the receipt to the cashier.
(5) The cashier inputs the receipt number printed on the receipt to the POS terminal.
(6) The inputted receipt number is transmitted to the main server from the POS terminal. The main server reads the purchase information corresponding to the received receipt number, and transmits the purchase information to its POS terminal.
(7) The purchase information transmitted to the POS terminal includes individual commodity information and total purchase amount. Therefore, a checkout process such as a payment is carried out between the cashier and the customer with the total purchase amount or the like being displayed or printed.

In the utilization form 1 described above, on the POS terminal, the customer does not input the information of the individual commodity, but he/she only confirms the total amount of the purchase, and makes a checkout process. Therefore, the process can be finished in a short period, with the result that the congestion at the checkout counter can be advantageously eased.

### Conventional Utilization Form 2

There is a system in which a self-checkout terminal only inputs the purchase information without the connection of the self-checkout terminal to the network, and the total amount of all purchases is printed on a receipt. Here, it is supposed that the POS terminal and the main server are connected to each other through the network.
(1) A customer personally inputs the information of his/her purchase by using the self-checkout terminal. It is supposed that the self-checkout terminal stores beforehand commodity codes and units of all commodities available in this store.

In this case, the customer makes an operation of reading a bar-code attached to each commodity with a scanner, whereby information in which the purchases are classified into a category is generated, and the total amount of all purchases is calculated.
(2) On the self-checkout terminal, category classification information of the purchase and the total amount of the purchases are printed on a receipt as character information, and a bar-code including these information pieces is also printed on the receipt.
(3) Thereafter, the customer goes to the POS terminal with the receipt having printed thereon the bar-code and the purchases, and delivers the receipt to the cashier of the POS terminal.
(4) The cashier at the POS terminal reads the bar-code printed on the received receipt with a scanner. The cashier confirms the total purchase amount acquired from the bar-code, and makes a checkout process such as payment with the customer.
(5) On the POS terminal, the category classification information of the purchases and the information of the total purchase amount are extracted from the read bar-code. The extracted information is transmitted to the main server connected to the POS terminal through the network.

With this process, the main server stores the total purchase amount in one transaction of the customer and the category classification information of the purchases in this transaction.

In the utilization form 2 described above, the self-checkout terminal is not connected to the network. Therefore, the location where the self-checkout terminal is set can freely be designed. Since the information of the individual commodity is not inputted on the POS terminal, the congestion at the checkout counter can advantageously be eased.

POS systems described in Japanese Unexamined Patent Publications No. 8-142871 and No. 4-293198 have been proposed as a system for easing the congestion at the checkout counter.

However, in the above-mentioned conventional utilization form 1, the self-checkout terminal has to be connected to a main POS terminal or a main server through network. Therefore, the location where the self-checkout terminal is set is fixed, and the self-checkout terminal cannot be set on a location unable to connect to the network.

In the conventional utilization form 2, the information included in the bar-code is limited to the category classification information and the total purchase amount due to the storage capacity of the bar-code. Therefore, the individual information (single-item information such as a commodity code of each commodity, and purchase quantity) of a purchase cannot be transmitted to the main server. Accordingly, it is difficult for the main server to manage sales of each purchase (e.g., to manage sales quantity) inputted on the self-checkout terminal.

In the other conventional POS systems, a shopping cart is provided with a special input device or a weight scale for weighing a commodity in order to shorten the waiting time at a checkout counter. However, a new shopping cart has to be introduced, which needs new business investment.

### SUMMARY OF THE INVENTION

The present invention provides a commodity information registration system that inputs purchase information by using a self-checkout terminal not connected to network, and that can easily manage sales information for each purchase inputted on the self-checkout terminal.

The present invention provides a commodity information registration system comprising an input terminal that inputs commodity information, and a checkout terminal that performs a checkout process of a purchase, wherein the input terminal comprises a first bar-code input unit that reads a bar-code including commodity specifying information, a bar-code analyzing unit that analyses the read bar-code so as to acquire the commodity specifying information, a two-dimensional code generating unit that generates a two-dimensional code including one or plural acquired commodity specifying information, and an output unit that outputs the generated two-dimensional code; and the checkout terminal comprises a second code input unit that reads the outputted two-dimensional code, a two-dimensional code analyzing unit that analyzes the read two-dimensional code so as to acquire the commodity specifying information included in the two-dimensional code, an amount calculating unit that calculates sales proceeds for each purchase and a total amount of all purchases in one transaction by using the commodity specifying information acquired from the two-dimensional code, and a storage unit that stores sales data including the sales proceeds for each purchase in one transaction.

With this configuration, the input terminal generates the two-dimensional code including the commodity specifying information of the purchase, while the checkout terminal reads the two-dimensional code so as to calculate the sales proceeds for each purchase. Therefore, even if the input terminal and the checkout terminal are set on remote places without the connection through network, the sales information of each purchase for all purchases in one transaction can be acquired from the two-dimensional code.

The cashier just has to make the operation of reading the two-dimensional code on the checkout terminal. Accordingly, the cashier's operation load can be reduced, and the time taken for the checkout process can be shortened. Consequently, the waiting time of the customer who tends to make payment for the purchase at the checkout terminal can be shortened.

### BRIEF DESCRIPTION OF THE DRAWINGS

FIG. 1 is a diagram schematically showing a configuration of a commodity information registration system according to one embodiment of the present invention;

FIG. 2 is a block diagram showing a configuration of a self-checkout terminal according to one embodiment of the present invention;

FIG. 3 is a block diagram showing a configuration of a POS terminal according to one embodiment of the present invention;

FIG. 4 is a block diagram showing a configuration of a server according to one embodiment of the present invention;

FIG. 5 is a flowchart showing a registration process of the self-checkout terminal according to one embodiment of the present invention;

FIG. 6 is a flowchart showing an information process of the POS terminal according to one embodiment of the present invention;

FIG. 7 is a flowchart showing a sales management process of the server according to one embodiment of the present invention;

FIG. 8 is an explanatory view of a receipt issued from the self-checkout terminal according to one embodiment of the present invention;

FIG. 9 is an explanatory view of a receipt having printed thereon sales data on the POS terminal according to one embodiment of the present invention; and

FIGS. 10(a) and 10(b) are explanatory views of an error message displayed onto a display unit according to one embodiment of the present invention.

### DESCRIPTION OF THE PREFERRED EMBODIMENTS

The present invention provides a commodity information registration system comprising an input terminal that inputs commodity information, and a checkout terminal that performs a checkout process of a purchase, wherein the input terminal comprises a first bar-code input unit that reads a bar-code including commodity specifying information, a bar-code analyzing unit that analyses the read bar-code so as to acquire the commodity specifying information, a two-dimensional code generating unit that generates a two-dimensional code including one or plural acquired commodity specifying information, and an output unit that outputs the generated two-dimensional code; and the checkout terminal comprises a second code input unit that reads the outputted two-dimensional code, a two-dimensional code analyzing unit that analyzes the read two-dimensional code so as to acquire the commodity specifying information included in the two-dimensional code, an amount calculating unit that calculates sales proceeds for each purchase and a total amount of all purchases in one transaction by using the commodity specifying information acquired from the two-dimensional code, and a storage unit that stores sales data including the sales proceeds for each purchase in one transaction.

The input terminal is put on a position where it cannot be connected to network.

The input terminal further comprises a data input unit that inputs a purchase quantity of the same commodity, wherein the two-dimensional code generated by the two-dimensional code generating unit includes the purchase quantity.

The bar-code is attached to a purchase, and includes a commodity code for specifying the purchase.

The output unit is a print unit that prints the generated two-dimensional code on a predetermined sheet medium.

The two-dimensional code includes the commodity specifying information of all purchases in one transaction, and the commodity specifying information included in the two-dimensional code has a commodity code of each commodity, and a purchase quantity of the commodity.

The sales data stored in the storage unit includes single-item information composed of a commodity code, a commodity name, a purchase quantity, and sales proceeds, for each purchase.

The checkout terminal is connected to a server that manages sales of all commodities through network, and further comprises a communication unit that transmits the sales data of each commodity stored in the storage unit to the server.

The checkout terminal comprises a weighing unit that measures all purchases in one transaction by weight; a weight calculating unit that calculates a purchase weight of each purchase from the commodity specifying information acquired from the two-dimensional code and a standard weight of each commodity stored beforehand in the storage unit, so as to calculate the total weight of all purchases in one transaction; and a weight comparing unit that compares the measured weight and the total weight, and determines that the transaction is fair when the difference between both weights falls within a predetermined weight setting range.

The present invention will be described below with reference to embodiments shown in the drawings.

It is to be noted that the present invention is not limited by these embodiments.

### Configuration of Commodity Information Registration System of Present Invention

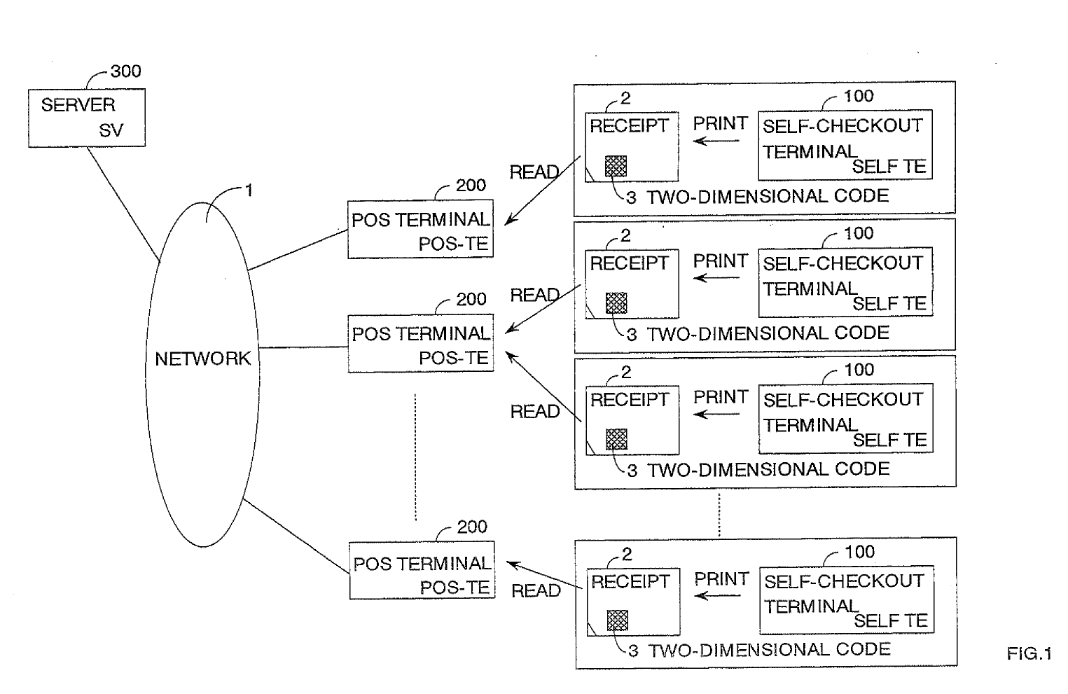

FIG. 1 is a view schematically showing a configuration of a commodity information registration system according to one embodiment of the present invention.

In FIG. 1, the commodity information registration system according to the present invention includes a self-checkout terminal 100 (hereinafter also referred to as a self TE), a POS terminal 200 (hereinafter also referred to as a POS-TE), and a server 300 (SV).

The self TE 100 corresponds to the above-mentioned input terminal, and the POS terminal 200 corresponds to the above-mentioned checkout terminal.

The server 300 and the POS-TE 200 are connected via network 1 such as LAN, in order that data such as sales information is received and transmitted between the server 300 and the POS-TE 200.

The self TE 100 is mainly a terminal that can be placed on a position where it cannot be connected to network. The self TE 100 may be a terminal that does not have a function of connecting to network.

Therefore, the self TE 100 has a lot of flexibility in the installation, whereby it can be placed on any positions in a store. Accordingly, it may be placed on a location where a heavy congestion for the checkout process can be avoided, or on a location convenient for a customer, who have bought commodities, to input commodity information.

It is supposed that the self TE 100 and the POS-TE 200 are both the terminals placed in one store, and one or plural self TE 100 and POS-TE 200 are placed according to a scale of the store.

In FIG. 1, the server SV 300 is an information processing apparatus that manages sales of all commodities sold in this store. For example, the server SV 300 stores the single-day total sales proceeds of this store, sales volume and sales proceeds for each item sold in this store, and information involved with a purchaser, such as the number of purchasers or payment method. The server SV 300 may be placed in the same store, or may be placed in a remotely-positioned building different from the store.

The POS terminal 200 executes a checkout process of purchases, and it is a register that executes a payment process or credit process of the total purchase amount on a transaction basis for all items purchased by a customer. A cashier in the store operates this terminal.

The self TE 100 corresponds to the above-mentioned input terminal. It is a terminal used by a customer for personally inputting the commodity information of his/her purchases. This terminal issues a receipt 2 having printed thereon the inputted information of the purchases.

The customer brings the commodities he/she intends to buy to the self TE 100, and allows the self TE 100 to read a bar-code attached to each commodity with a scanner provided to the self TE 100. The bar-code attached to each commodity includes commodity specifying information for specifying the commodity. The commodity specifying information includes a “commodity code” of the commodity, for example.

The commodity code, which is the commodity specifying information, is acquired by analyzing the read bar-code.

After the bar-code reading is finished for all commodities the customer intends to buy, the customer makes a key input indicating that the input is finished, whereby a printer provided to the self TE 100 outputs a receipt on which the information of the purchases is printed.

The present invention is characterized in that the information printed on the receipt 2 includes not only character information but also a two-dimensional code 3. Therefore, the self TE 100 has a function of generating the two-dimensional code 3 in order to print the two-dimensional code 3.

The character information includes at least a “commodity name” of the purchase and a “quantity” of the purchase for each purchase. The “commodity name” is acquired from the “commodity code” included in the bar-code by referring to later-described set data 111.

The two-dimensional code 3 is code information formed by encoding a numerical value according to a predetermined standard, and includes one or more commodity specifying information acquired by reading one or more bar-codes. For example, it includes a “commodity code” for each purchase, and the purchase quantity of the same purchase (hereinafter merely referred to as “quantity”) specified by the commodity code.

When there are plural purchases in one transaction, the commodity specifying information of all purchases in one transaction, i.e., the commodity codes and quantities of all of plural purchases, are included in the two-dimensional code 3.

The quantity may be inputted by use of a keyboard that is a later-described data input unit. Alternatively, when there are plural commodity codes of the same commodity read from the bar-code, this number may be counted to acquire the quantity.

The POS terminal 200 according to the present invention has a function of reading the two-dimensional code 3, which is printed on the receipt 2 issued from the self TE 100.

When a customer goes to the POS terminal 200 with the receipt issued from the self TE 100, and delivers the receipt to a cashier of the POS terminal, the cashier allows the POS terminal 200 to read the two-dimensional code 3, printed on the receipt 2, with the scanner provided to the POS terminal 200.

When the POS terminal 200 succeeds in reading the two-dimensional code 3, the POS terminal 200 analyzes the two-dimensional code 3, thereby acquiring the commodity specifying information included in the two-dimensional code. For example, the “commodity code” and “quantity” are acquired as the commodity specifying information for each purchase. The POS terminal 200 executes a later-described checkout process by using the commodity specifying information acquired from the two-dimensional code. For example, it calculates the sales proceeds for each purchase, and calculates the total amount of all purchases of the customer in one transaction, whereby the payment of the purchases or delivery of changes is done.

The POS terminal 200 stores, for each commodity, sales data including the commodity specifying information (commodity code, quantity) acquired from the two-dimensional code 3 for each commodity, the commodity name, the sales proceeds of the commodity calculated in the checkout process, and the total amount of the customer in one transaction. Transmission data described below is generated from the sales data, and the transmission data for each commodity is transmitted to the server SV 300 via the network 1.

The sales data and the transmission data include later-described single-item information (commodity code, commodity name, purchase quantity, and sales proceeds).

The above is the outline of the process executed in the system according to the present invention.

The present invention is characterized in that the two-dimensional code 3 is printed on the receipt 2 issued from the self TE 100, and the two-dimensional code 3 includes the “commodity code” and “quantity” for each commodity purchased by the customer.

The POS terminal 200 reads and analyzes the two-dimensional code 3 so as to reconstruct the same, whereby all commodities purchased by the customer can be specified, and the purchase quantity for each purchase can be specified. A unit price of a commodity is stored beforehand in the POS terminal 200 in order to calculate the sales proceeds of the purchase.

Specifically, the information (commodity name, purchase quantity, sales proceeds) for each of all purchases can be confirmed by analyzing the two-dimensional code 3.

In this case, the information of each purchase can be confirmed only by performing once the operation of reading the two-dimensional code 3, printed by the POS terminal 200, with the scanner.

Accordingly, it is unnecessary to repeat many times the operation of reading the bar-code for each purchase with the scanner on the POS terminal 200, resulting in that the load of the cashier of the POS terminal can be reduced, and the time taken to input the commodity information can be shortened.

Since the total amount of all purchases of the customer is calculated by using the information reconstructed from the two-dimensional code 3, the checkout process can be done between the cashier and the customer just after the two-dimensional code is read, which can shorten the waiting time for the customer at the checkout counter provided with the POS terminal 200.

Since the transmission data including the single-item information for each item acquired from the two-dimensional code 3 is transmitted to the server SV 300, the server SV 300 can manage the sales (manage the sales quantity, and sales proceeds) for each purchase, even if the self TE 100 is set in an environment where it cannot be connected to network.

### Configuration of Self-Checkout Terminal (Self TE)

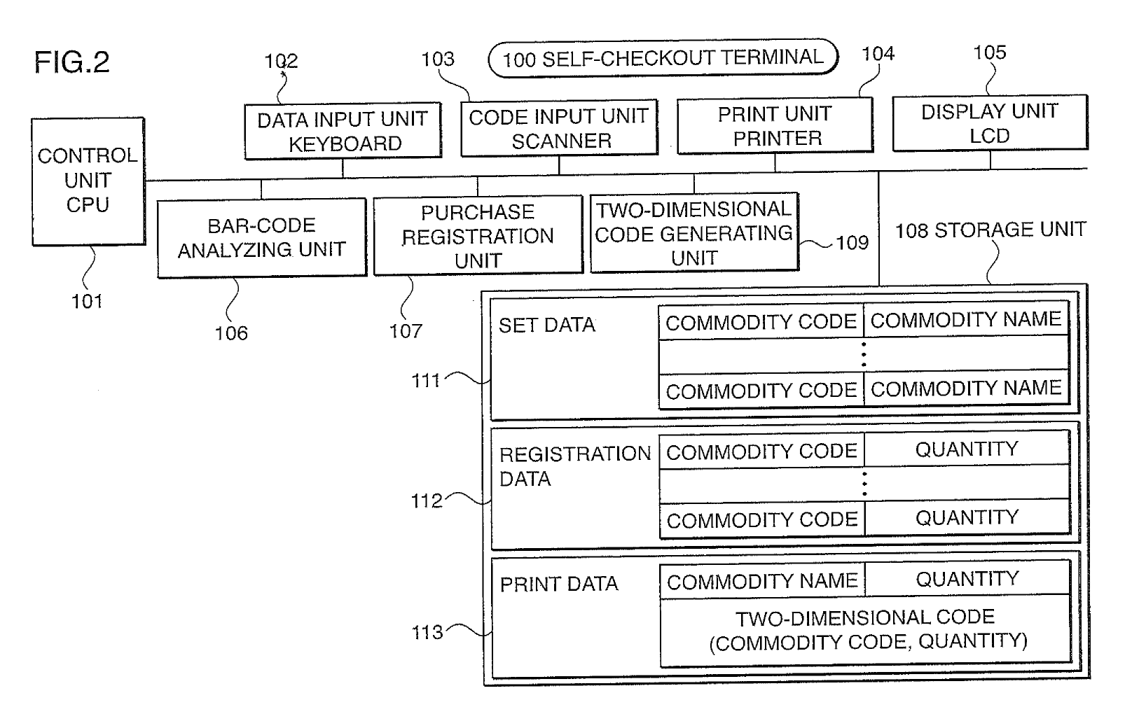

FIG. 2 is a block diagram showing a configuration of the self-checkout terminal (self TE) 100 according to one embodiment of the present invention.

The self TE 100 according to the present invention is an input terminal from which commodity information is inputted. It mainly includes a keyboard serving as the data input unit 102, the scanner serving as a code input unit 103, a printer serving as a print unit 104, a display device such as an LCD, CRT, or PDP serving as a display unit 105, a bar-code analyzing unit 106, a purchase registration unit 107, a two-dimensional code generating unit 109, a storage unit 108, and a control unit 101.

The control unit 101 is realized by a microcomputer including a CPU, ROM, RAM, I/O controller, and a timer, and it controls operations of other blocks (102 to 109).

Particularly, the bar-code analyzing unit 106, the purchase registration unit 107, and the two-dimensional code generating unit 109 are realized through an organic operation of hardware by the CPU 101 based upon a control program stored beforehand in the ROM or RAM.

The data input unit 102 is a unit to which a user, particularly a customer of a store in the present invention, inputs data. When the customer buys a commodity in plural numbers, for example, he/she inputs the number with the keyboard.

The customer inputs not only the quantity, but also an ID number, an instruction of canceling the commodity that has already been registered, or an end of the input of purchases.

A pointing device such as a mouse or touch panel may be used as the data input unit 102, instead of the keyboard.

The code input unit 103 corresponds to a first code input unit that reads a bar-code including the above-mentioned commodity specifying information. The code input unit 103 is a unit to which the bar-code attached to the commodity is inputted. A scanner that can read the bar-code is mainly used as the code input unit 103.

Bar-codes of various standards can be used as the bar-code to be inputted, and the bar-code is not particularly limited. Examples of one-dimensional bar-code include JAN code, and ISBN code.

When the two-dimensional code is attached to the commodity, a code reader that can read the two-dimensional code such as a QR code may be used, Various information pieces are considered to be included in the bar-code attached to the commodity. In the present invention, it is supposed that the bar-code includes at least identification number (commodity code) by which the commodity can be specified.

Specifically, at least the commodity code can be acquired by reading the bar-code.

The print unit 104 corresponds to an output unit for outputting the above-mentioned two-dimensional code. The print unit 104 prints the two-dimensional code, generated by the two-dimensional code generating unit, on a predetermined sheet medium. Specifically, the print unit 104 is a device that issues the receipt 2, and it is a printer that can print not only the character information but also the two-dimensional code 3.

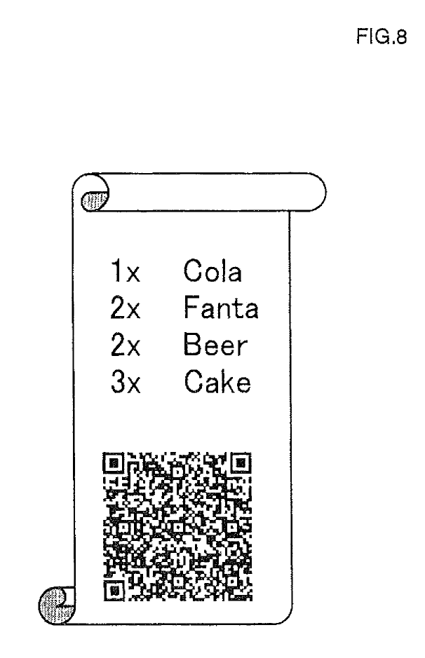

The later-described receipt 2 shown in FIG. 8 is printed at the self TE 100 according to the present invention.

The information printed on the receipt 2 includes the character information containing the commodity name and quantity, and the two-dimensional code 3.

The two-dimensional code 3 includes at least the commodity code corresponding to the commodity name, and the purchase quantity of the commodity. When there are plural purchases, the information of all purchases is included in one two-dimensional code.

The display unit 105 is a unit for displaying the information inputted by the customer.

For example, the display unit 105 displays on a screen the commodity name corresponding to the commodity code acquired from the read bar-code, or the inputted quantity of the commodity. The customer confirms whether he/she inputs correctly or not through the display.

The bar-code analyzing unit 106 analyzes the bar-code read by the code input unit 103 so as to acquire the commodity specifying information included in the bar-code.

In the present invention, the commodity code is acquired from the bar-code.

The purchase registration unit 107 is a unit for storing the information acquired by the bar-code analyzing unit 106 or the information inputted from the data input unit 102 into the storage unit 108. It also generates print data to be printed from the printer.

For example, the purchase registration unit 107 stores registration data 112, including the commodity code acquired from the bar-code and the inputted quantity of the commodity, into the storage unit 108.

The purchase registration unit 107 also extracts the commodity name corresponding to the acquired commodity code from set data 111, which is stored beforehand in the storage unit 108, thereby generating the print data including the commodity name, the quantity, and the two-dimensional code generated by the two-dimensional code generating unit 109.

The two-dimensional code generating unit 109 generates the two-dimensional code 3 including one or plural commodity specifying information acquired by the bar-code analyzing unit.

As described above, in the present invention, the two-dimensional code 3 includes the commodity code acquired from the bar-code attached to the commodity, and the purchase quantity of the commodity corresponding to the commodity code, for all purchases.

Specifically, the two-dimensional code generating unit 109 generates one two-dimensional code 3 including the “commodity code” and “quantity” of each of all inputted purchases in one transaction by one customer.

The storage unit 108 mainly stores the set data 111, the registration data 112, and the print data 113, and also stores data temporarily used for performing a print process or a display process. The data fixedly stored in the storage unit 108 may be stored in the ROM. On the other hand, data that is to be added, changed, and deleted is stored in a rewritable memory such as RAM, flash memory, or hard disk.

The set data 111 is stored beforehand in the self TE 100, and includes information involved with all commodities sold in a store.

For example, as shown in FIG. 2, the set data 111 stores the commodity name and the commodity code of one item, wherein the commodity name and the commodity code are associated with each other.

In the present invention, the self TE 100 is not connected to network. Therefore, the set data 111 is downloaded to the storage unit 108 of the self TE 100 from a storage medium, which stores the set data, for update before the store opens.

The set data 111 may include not only the “commodity code” and “commodity name” shown in FIG. 2 but also information such as valid period of the information or a limited number of the purchase quantity.

The registration data 112 is stored in the purchase registration unit 107 as described above.

For example, the registration data 112 includes the “commodity code” extracted from the bar-code attached to the commodity and the “quantity” inputted by the customer with the self TE 100.

The print data 113 is printed on the receipt 2 by the print unit 104, and includes the character information and the two-dimensional code. The printed character information is, for example, the “commodity name” and “quantity”, and the customer confirms whether or not he/she correctly inputs the commodities he/she buys as seeing the character information printed on the receipt 2.

The printed two-dimensional code 3 includes the commodity code and quantity of each purchase as described above, and it is utilized during the checkout process by the POS terminal 200.

The single-item information for each purchase reconstructed from the printed two-dimensional code 3 is transferred to the server 300 from the POS terminal 200 through the network, and utilized for the sales management for each commodity.

FIG. 8 is an explanatory view of the receipt issued from the self TE 100 according to one embodiment.

FIG. 8 shows the receipt 2 on which the character information (quantity, commodity name) of four purchases and the two-dimensional code 3 are printed.

### Configuration of POS Terminal (POS-TE)

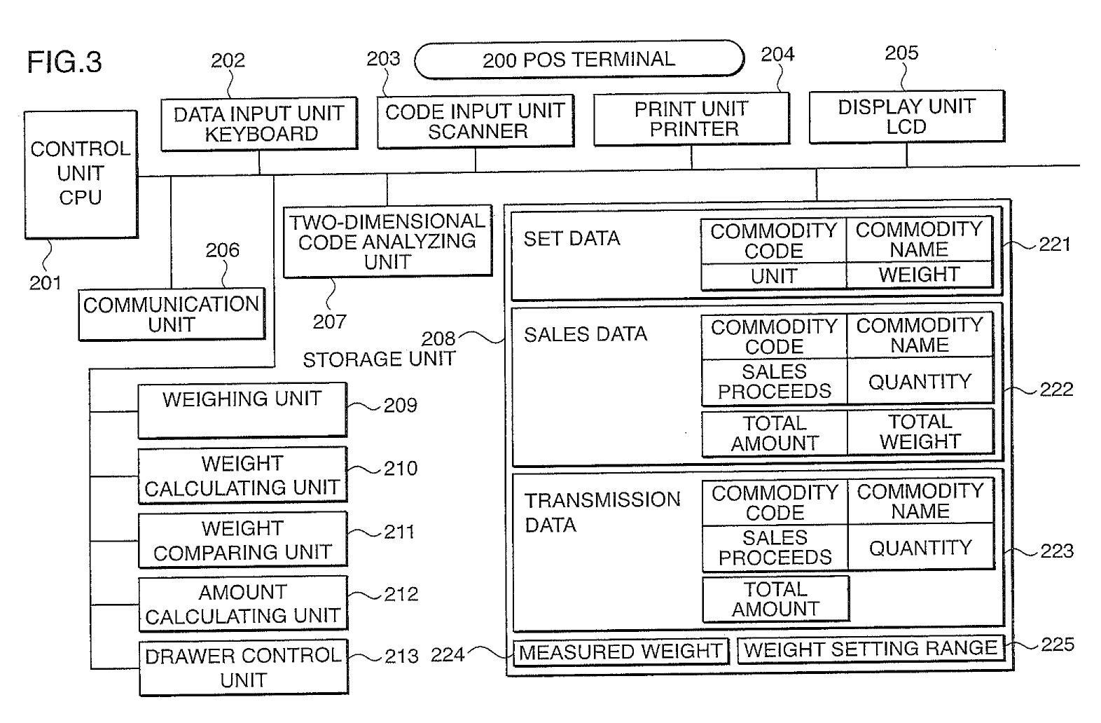

FIG. 3 is a block diagram showing the configuration of the POS terminal (POS-TE) 200 according to one embodiment of the present invention.

The POS-TE 200 in the present invention is a checkout terminal executing the checkout process of the purchases. It is mainly composed of a keyboard serving as a data input unit 202, a scanner serving as a code input unit 203, a printer serving as a print unit 204, a display device such as LCD, CRT, or PDP serving as a display unit 205, a communication unit 206 that communicates with the server 300, a two-dimensional code analyzing unit 207, a weighing unit 209, a weight calculating unit 210, a weight comparing unit 211, an amount calculating unit 212, a drawer control unit 213, a storage unit 208, and a control unit 201.

The control unit 201 is realized by a microcomputer, and it controls operations of other blocks (202 to 209).

The data input unit 202, the code input unit 203, the print unit 204, and the display unit 205 are almost equal to those provided to the self TE 100.

The code input unit 203 corresponds to a second code input unit that reads the two-dimensional code, and it is a scanner that can read the two-dimensional code 3 printed on the receipt 2 issued from the self TE 100.

The communication unit 206 is a communication module including hardware and software that can be connected to the network 1. The communication unit 206 sends and receives data with a communication protocol determined beforehand in the network 1 such as LAN.

When one server 300 and n POS terminals 200 are connected to the network (LAN) 1 in the present invention, for example, one-to-n communication is established, wherein the sales data generated in the checkout process at each POS terminal 200 is mainly transmitted to the server 300.

The two-dimensional code analyzing unit 207 analyzes the two-dimensional code 3 read by the code input unit 203, and acquires the commodity specifying information included in the two-dimensional code 3.

As described above, when the two-dimensional code 3 on the receipt 2 issued from the self TE 100 includes the commodity code and the quantity, this commodity code and the quantity are extracted.

Since the commodity code and the commodity name are stored in the later-described set data 221 in the storage unit 208 as being associated with each other, the corresponding commodity name is also acquired from the extracted commodity code through the analysis of the two-dimensional code.

The weighing unit 209 measures all commodities purchased by the customer in one transaction by weight (measured weight M1), and it is a so-called weight scale.

For example, all purchases are put into a store's exclusive basket, and the exclusive basket is placed onto the weight scale for weighing. The measured weight is stored in the storage unit 208 as a measured weight 224. The measured weight (M1) 224 is the actual weight of all purchases.

The weight calculating unit 210 calculates the purchase weight for each purchase by using the commodity specifying information acquired from the two-dimensional code 3 and a standard weight of each commodity stored beforehand in the set data 221 in the storage unit, and also calculates the total weight (total weight M0) of all purchases in one transaction of the customer.

The weight calculating unit 210 reads the standard weight of the commodity corresponding to the commodity code acquired from the two-dimensional code 3 from the set data 221 in the storage unit 208, and multiplies the quantity acquired from the two-dimensional code by the read weight, thereby calculating the weight (purchase weight) of the purchases. The weight calculating unit 210 performs this weight calculation for all purchases, thereby calculating the total weight (M0) of all purchases.

The weight comparing unit 211 compares the measured weight M1 measured by the weighing unit 209 and the total weight M0 calculated by the weight calculating unit 210.

Here, it is determined whether the difference (M1−M0) between both weights falls within a predetermined “weight setting range 225” or not. When the difference falls within the predetermined weight setting range, the transaction is determined to be fair.

It is supposed that “±10% of the total weight M0” is set as the weight setting range 225, for example. When the calculated total weight is 10 kg, the weight setting range is 10 kg±1 kg. If the actual measured weight M1 is 9 kg or more and 11 kg or less, the inputted information of the purchases and the actual commodities actually purchased are considered to be the same, so that it is regarded that the queer purchase is not done.

Specifically, the comparing process by the weight comparing unit is used for checking the queer purchase.

The weight setting range 225 is not only set in terms of % as described above, but also set such that the upper limit weight and lower limit weight are represented by numerical values. Alternatively, the weight setting range 225 may be changed depending upon each store.

The amount calculating unit 212 calculates the sales proceeds for each purchase so as to calculate the total amount of all purchases in one transaction by using the commodity specifying information acquired from the two-dimensional code 3.

For example, the amount calculating unit 212 reads the “unit” of the commodity corresponding to the commodity code acquired from the two-dimensional code 3 from the set data 221, which is set beforehand, in the storage unit 208, and multiplies the purchase quantity acquired from the two-dimensional code 3 by the unit, thereby calculating the sales proceeds of the purchase.

Similarly, the amount calculating unit 212 calculates the sales proceeds for each purchase, and calculates the total amount (total purchase amount) by adding the sales proceeds for each purchase.

The sales proceeds for each purchase and the total amount are stored in the storage unit 208 as the sales data 222.

The drawer control unit 213 controls a box accommodating cash.

The storage unit 208 mainly stores the set data 221, the sales data 222, the transmission data 223, the measured weight 224, and the weight setting range 225. The storage unit 208 also stores temporal data needed for the information processing executed in the POS terminal 200.

In the set data 221, information involved with all items sold in the store is set beforehand. The set data 221 is updated once a day before the store opens.

The set data 221 stores, for example, information such as a commodity code, commodity name, unit, and weight for each item.

As described later, the commodity name, unit, and weight corresponding to the commodity code acquired from the two-dimensional code 3 is read from the set data 221.

The sales data 222 stores the sales proceeds for each of purchases in one transaction. It is sales information, corresponding to one transaction, contained in the receipt 2 the customer brings.

The sales data 222 includes, for example, “commodity code, commodity name, sales proceeds, quantity” of one item, and stores the total amount and total weight of one transaction. When the two-dimensional code 3 printed on the receipt 2 the customer brings includes the commodity code and quantity, the corresponding commodity name, unit, and weight are extracted from the commodity code on the two-dimensional code 3 with reference to the set data 221. The sales proceeds of the corresponding commodity are calculated from the quantity on the two-dimensional code 3 and the extracted quantity, and the purchase weight of the commodity is calculated from the quantity and extracted weight.

The sales proceeds of each commodity are added up, whereby the total amount of all purchases is calculated. The purchase weight of each commodity is added up, whereby the total weight of all purchases is calculated.

The transmission data 223 is transmitted from the POS terminal 200 to the server 300.

The transmission data 223 includes, for example, a commodity code, commodity name, sales proceeds, and quantity of one commodity. The total amount in one transaction may also be included in the transmission data 223. The information of the customer who buys the commodity or manner of payment may also be included in the transmission data 223.

Since the purchase information for each commodity is included in the transmission data 223, the server 300 can manage sales for each commodity. It is supposed below that the information including a commodity code, commodity name, sales proceeds, and quantity for one commodity is referred to as single-item information.

### Configuration of Server

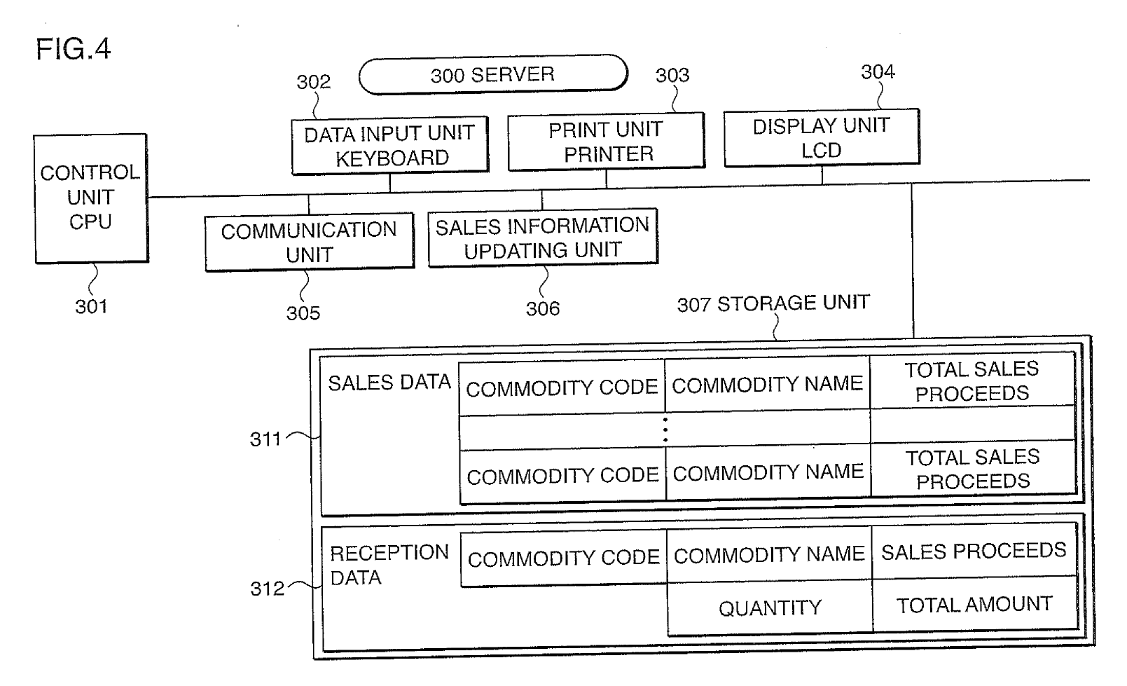

FIG. 4 is a block diagram showing the configuration of the server 300 according to one embodiment.

The server 300 according to the present invention mainly includes a keyboard serving as a data input unit 302, a printer serving as a print unit 303, a display device such as LCD, CRT, or PDP serving as a display unit 304, a communication unit 305 that communicates with the POS terminal 200, a sales information updating unit 306, a storage unit 307, and a control unit 301.

The control unit 301 is realized by a microprocessor, and it controls operations of other blocks (302 to 307).

The data input unit 302, the print unit 303, and the display unit 304 may be those having functions same as those of the self TE or the POS terminal.

The communication unit 305 is a communication module having the function same as that of the POS terminal 200, and sends and receives data to and from the communication unit 206 of the POS terminal 200.

The sales information updating unit 306 receives the transmission data 223 sent from the POS terminal 200, and then, updates the sales data 311 stored in the storage unit 307 by using the single-item information for each item included in this data.

The storage unit 307 mainly stores the sales data 311, and reception data 312.

The reception data 312 is the same as the transmission data 223 sent from the POS terminal 200.

The sales data 311 is data of tally for each store, or data of tally for each item, and it is data that becomes the reference of management data utilized in each section such as a work for sale, work for stock, ordering work, or accounting work.

As shown in FIG. 4, for example, the sales data 311 counted for each item is composed of a commodity code, commodity name, and total sales proceeds for each item.

Every time the server 300 receives the reception data 312, the sales information updating unit 306 adds the sales proceeds corresponding to the received commodity code to the sales proceeds corresponding to the same commodity code in the sales data 311.

### Process in Self-Checkout Terminal

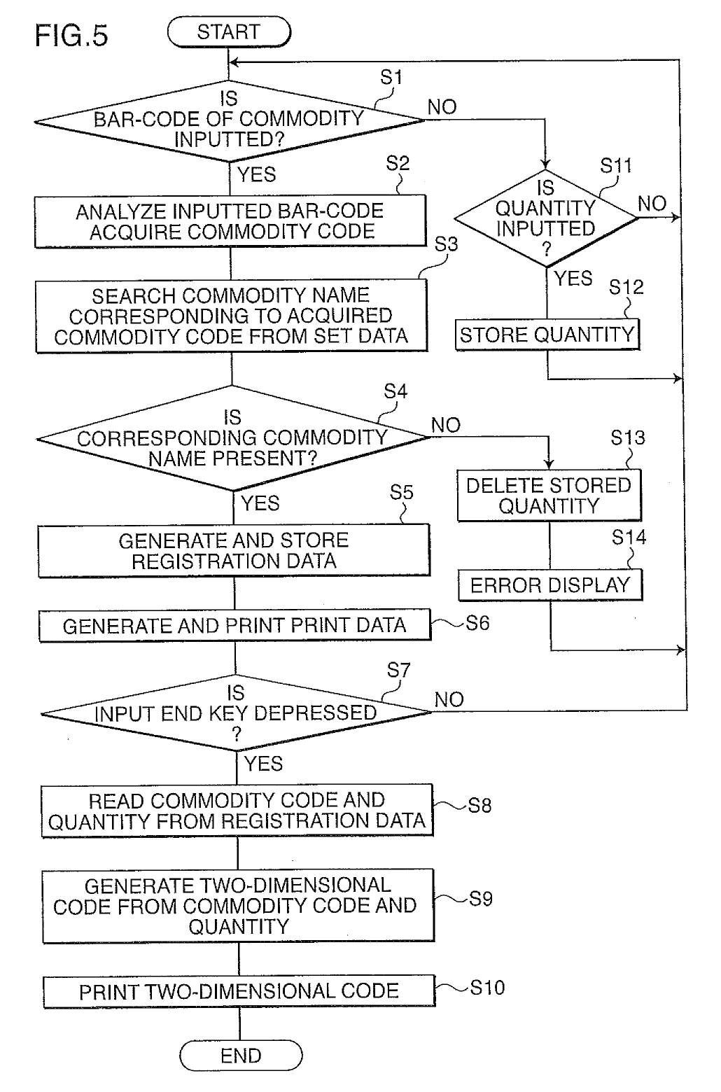

FIG. 5 is a flowchart showing an input process on the self-checkout terminal 100.

On the self TE 100, the customer personally inputs the information of his/her purchase, and the receipt having printed thereon the purchase information for the inputted purchase is issued.

Here, the customer is supposed to read the bar-code attached to the commodity with the scanner serving as the code input unit 103. When the customer buys the same commodity in plural numbers, he/she may repeat the operation of reading the bar-code of each commodity, but instead of this operation, he/she may directly input the purchase quantity by use of the keyboard serving as the data input unit 102.

In step S1 in FIG. 5, the control unit 101 checks whether a bar-code of a commodity is inputted from the code input unit 103 or not.

If the control unit 101 determines that the bar-code is inputted from the scanner, the process proceeds to step S2, and if not, proceeds to step S11.

In step S11, the control unit 101 checks whether a quantity is inputted from the keyboard or not.

If the control unit 101 determines that the quantity is inputted, the process proceeds to step S12, and if not, returns to step S1.

In step S12, the control unit 101 stores the inputted quantity to the storage unit 108. Thereafter, the process returns to step S1.

In step S2, the bar-code analyzing unit 106 analyzes the inputted bar-code. Since the bar-code includes the commodity code, the bar-code analyzing unit 106 acquires the commodity code, and stores the acquired commodity code in the storage unit 108.

In step S3, the commodity name corresponding to the commodity code acquired in step S2 is searched with reference to the set data 111 stored beforehand in the storage unit 108 so as to search.

In step S4, it is checked whether the commodity name corresponding to the acquired commodity code is present or not in the set data 111. If the corresponding commodity name is present, the process proceeds to step S5, and if not, proceeds to step S13.

In step S13, if a quantity has already been stored, this quantity is deleted, because the corresponding commodity name is not present.

In step S14, an error display is displayed on the display unit 105, indicating that the commodity inputted by the customer is not registered in the set data 111.

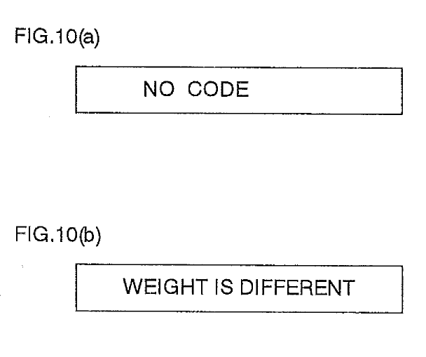

For example, a display of “no code” is made as shown in FIG. 10(a). The customer determines what to do according to the error display, i.e., he/she makes again an operation of reading the bar-code, or stops the input operation on the self TE 100. Then, the process returns to step S1.

In step S5, the purchase registration unit 107 generates the registration data 112, and stores the registration data 112 to the storage unit 108. The registration data 112 including the “commodity code” and “quantity” of the commodity inputted by the customer's input operation is generated, and this registration data 112 is stored in the storage unit 108.

In step S6, the purchase registration unit 107 generates the character information of the print data 113, and sends this print data to the print unit 104. The generated print data 113 includes the “commodity name” corresponding to the commodity code acquired from the bar-code, and the purchase quantity of the commodity.

It is to be noted that, in step S6, the print data composed of the character information is only generated, and the print data is not necessarily sent to the print unit 104. The print data may be transmitted to the print unit 104 together with the character information and the two-dimensional code in later-described step S10.

In step S7, it is checked whether the input end key is depressed or not by the data input unit 102.

When the customer finishes the input of the bar-codes and quantities of all purchases, he/she may only depress the input end key of the keyboard.

If the input end key is depressed, the process proceeds to step S8, and if not, returns to step S1.

In step S8, the two-dimensional code generating unit 109 reads all of the commodity names and quantities, stored for each purchase, from the registration data 112.

In step S9, the two-dimensional code generating unit 109 generates the two-dimensional code including the read commodity code and quantity by using a code generation method based upon a predetermined standard.

In step S10, the generated two-dimensional code is sent to the print unit 104 in order that the two-dimensional code is printed. As described above, the character information generated in step S6 and the two-dimensional code may be transmitted together to the print unit 104.

Thus, the print unit 104 prints the character information including the commodity name and quantity, and the two-dimensional code 3 having embedded thereon the commodity code and quantity on a predetermined receipt sheet as shown in FIG. 8.

In the manner described above, the receipt 2 having printed thereon the purchase information involved with the commodities purchased by the customer is issued. Thereafter, the customer brings the receipt 2 and the actual purchases to the POS terminal 200 where a cashier of the store waits.

### Process on POS Terminal

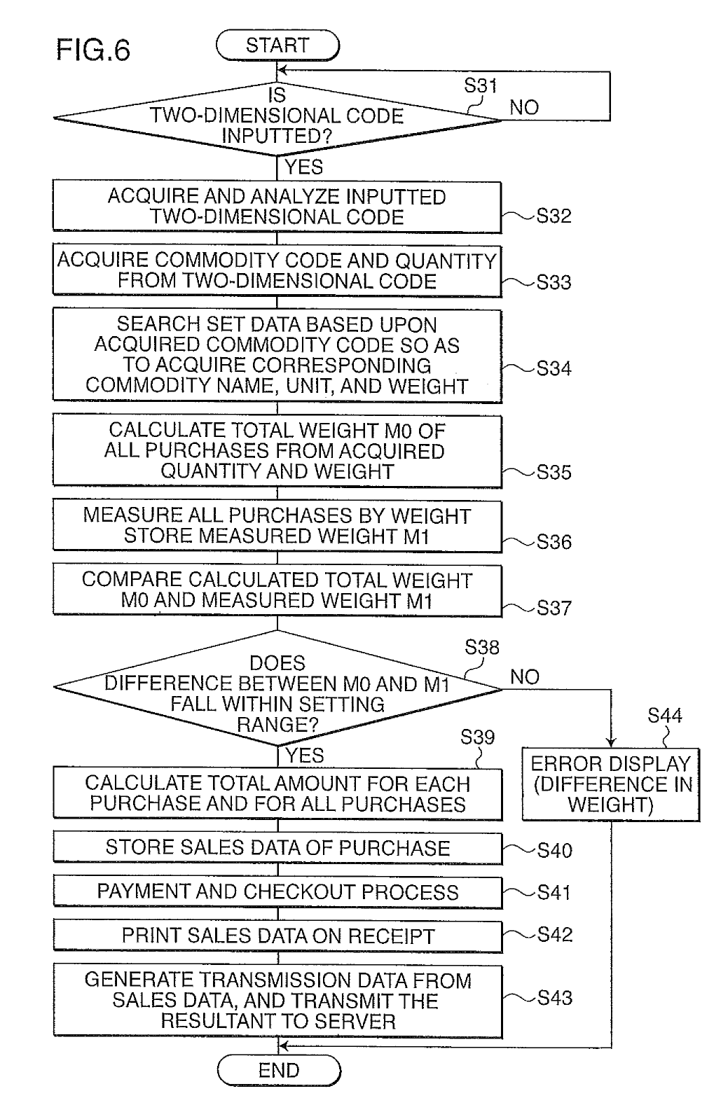

FIG. 6 shows a flowchart of an information processing on the POS terminal 200.

In the information processing, the reading of the two-dimensional code, the calculation of the purchase amount, the checkout process, and the transmission of the sales information of the commodity to the server, are mainly executed.

When the customer goes to the POS terminal 200 with the receipt 2 issued from the self TE 100, the cashier of the POS terminal 200 receives the receipt 2, and makes the operation of reading the two-dimensional code 3 printed on the receipt, as described above.

In step S31, the control unit 201 checks whether the two-dimensional code 3 is inputted from the code input unit 203 or not.

If the two-dimensional code 3 is inputted, the process proceeds to step S32, and if not, loops step S31.

In step S32, the two-dimensional code analyzing unit 207 acquires the inputted two-dimensional code 3, and analyzes the same. When the two-dimensional code 3 includes the commodity names and quantities of all purchases, these information pieces are reconstructed from the two-dimensional code.

In step S33, the two-dimensional code analyzing unit 207 acquires the commodity code and quantity reconstructed from the two-dimensional code 3, and stores the same in the storage unit 208 as a part of the sales data 222.

In step S34, the commodity name, unit, and weight, associated with the commodity code, are acquired from the set data 221 that is stored beforehand in the storage unit 208, based upon the acquired commodity code. This process is executed for all commodity codes acquired from the two-dimensional code 3.

In step S35, the weight calculating unit 210 multiplies the quantity by the weight acquired for one commodity code so as to calculate the purchase weight of the commodity corresponding to the commodity code. The weight calculating unit 210 also calculates the total weight M0 of the entire purchases obtained by adding the purchase weight of each commodity, and the obtained total weight M0 is stored in the storage unit 208.

In step S36, the weighing unit 209 measures the whole purchases brought by the customer by weight. The measured weight is stored in the storage unit 208 as the measured weight (M1)224.

In step S37, the weight comparing unit 211 compares the calculated total weight M0 and the measured weight M1.

The difference (M0−M1) between both weights may be calculated, and the obtained difference may be compared to the weight setting range 225 stored beforehand in the storage unit 208. With this process, the weight acquired from the information of the purchases inputted on the self TE 100 by the customer and the weight of the actual purchases brought by the customer are compared to check whether the difference between both weights falls within an allowable range or not, in order to check whether a queer purchase is done or not.

In step S38, when the difference (M0−M1) between both weights falls within the predetermined weight setting range 225, the process proceeds to step S39, and if not, proceeds to step S44.

When the process proceeds to step S39, this transaction is determined to be a fair transaction. When the process proceeds to step S44, this transaction is determined to be a queer transaction.

In step S44, the transaction is determined to be the queer transaction, because the total weight M0 obtained from the inputted information of the purchases, and the actual measured weight M1 of the purchases exceed the allowable range. Therefore, the error display indicating the difference in weight is displayed on the display unit 205.

For example, the error display such as “weight is different” is displayed as shown in FIG. 10(b). Thereafter, the transaction process for the commodities brought by the customer is ended.

In step S39, it is determined that there is no problem in validity of the purchases based upon the weight comparison, so that the amount calculating unit 212 calculates the sales proceeds for each purchase and the total amount of all purchases.

The sales proceeds of each commodity are obtained by multiplying the quantity acquired from the two-dimensional code 3 by the unit associated with the commodity code acquired from the set data 221.

The total amount is obtained by adding up the sales proceeds of all purchases.

In step S40, the sales data 222 of the purchase is stored in the storage unit 208.

The sales data 222 is the single-item information including the commodity code, commodity name, sales proceeds, and quantity of each purchase. The total amount or total weight may be included in the sales data.

In step S41, the cashier of the POS terminal 200 makes a checkout process with the customer. For example, the calculated total amount is displayed on the display unit 205. When the customer seeing this display pays for the purchases, the cashier makes a credit process by using the data input unit 202. When charges have to be paid with this credit process, the charges are calculated and displayed onto the display unit 205. The cashier sees this display, and delivers the charges to the customer.

In step S42, when the checkout process is ended, the sales data 222 is printed on the receipt, and the print unit 204 issues the receipt.

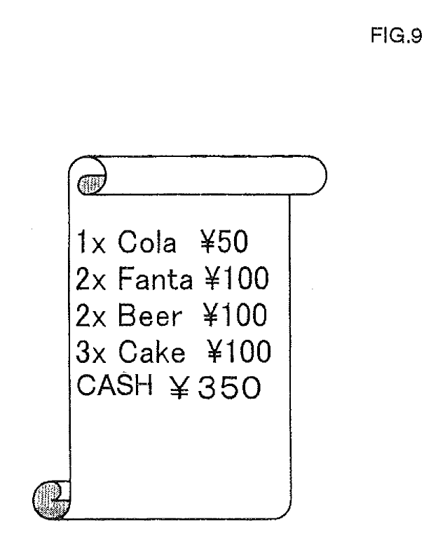

FIG. 9 shows one example of the receipt issued by the POS terminal 200.

FIG. 9 shows the receipt having printed thereon the quantity, commodity name, sales proceeds of the commodity, and total amount, out of the sales data 222. The information printed on the receipt is not limited thereto.

In step S43, the control unit 201 generates the transmission data 223 from the sales data 222, and transmits the transmission data to the server 300.

The transmission data 223 includes at least the single-item information (commodity code, commodity name, quantity, sales proceeds) of each commodity. The transmission data 223 may include the total amount of one transaction.

As described above, the payment and checkout process is executed on the POS terminal 200.

With this process, the input of the information for each commodity with the scanner is not carried out, but the cashier makes the operation of reading the two-dimensional code 3 printed on the receipt 2 on the POS terminal 200, whereby the next payment and checkout process can be executed.

Accordingly, the time taken for the input of the purchase information on the POS terminal can remarkably be shortened, resulting in that the waiting time of the customer on the POS terminal can also be shortened.

Since the single-item information of each purchase is transmitted from the POS terminal 200 to the server 300, the server can easily manage even the information of the commodity inputted from the self-checkout terminal 100 that is not connected to the network.

### Process on Server

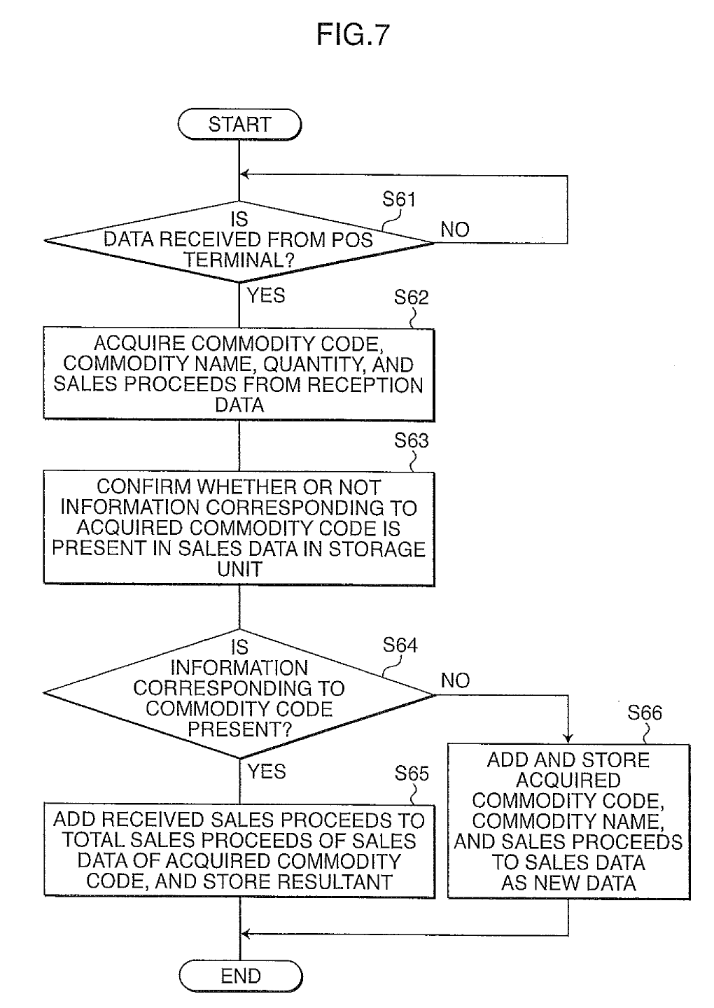

FIG. 7 shows the flowchart of the process on the server according to one embodiment.

Mainly, the server 300 receives the sales data from the POS terminal 200 so as to update the sales data for each commodity.

In step S61, the control unit 301 checks whether the data is transmitted from the POS terminal 200 or not. If the control unit 301 receives the data, the process proceeds to step S62, and if not, the process loops step S61.

In step S62, the control unit 301 acquires the commodity code, commodity name, quantity, sales proceeds, and total amount from the reception data 312 received from the POS terminal, and stores the resultant to the storage unit 307.

In step S63, the control unit 301 confirms whether or not the information corresponding to the commodity code acquired in step S62 has already been present in the sales data 311 in the storage unit 307.

When the information corresponding to the commodity code is present in step S64, the process proceeds to step S65, and if not, the process proceeds to step S66.

In step S65, the sales information updating unit 306 adds the sales proceeds of the corresponding commodity code in the reception data to the total sales proceeds of the sales data 311 corresponding to the acquired commodity code, and stores the resultant to the storage unit 307. When plural commodity codes are present in the reception data, the process in step S65 is executed for all commodity codes so as to update the sales proceeds of each commodity.

In step S66, a commodity code, which has not been present in the sales data in the storage unit 307, is added to the sales data 311 as new data. Specifically, the received commodity code, commodity name, and sales proceeds are added to the sales data 311.

With this process, the sales data for each commodity is added and updated on the server 300. Particularly, even the sales of the commodity inputted by the self TE 100 that is not connected to the network can be managed on the server 300 by reading the two-dimensional code 3, printed on the receipt 2 issued from the self TE 100, by the POS terminal.

According to the present invention, the input terminal generates the two-dimensional code including the commodity specifying information of the purchase, while the checkout terminal reads the two-dimensional code so as to calculate the sales proceeds for each purchase. Therefore, even if the input terminal and the checkout terminal are set on remote places without the connection through network, the sales information of each purchase for all purchases in one transaction can be acquired from the two-dimensional code.

The sales information of each commodity can be acquired, when the cashier just has to make the operation of reading the two-dimensional code on the checkout terminal. Accordingly, the operation load of the cashier on the checkout terminal can be reduced, and the time taken for the checkout process can be shortened.

What is claimed is:

1. A commodity information registration system comprising an input terminal that inputs commodity information, and a checkout terminal that performs a checkout process of a purchase, wherein
the input terminal comprises a first bar-code input unit that reads a bar-code including commodity specifying information, a bar-code analyzing unit that analyses the read bar-code so as to acquire the commodity specifying information, a two-dimensional code generating unit that generates a two-dimensional code including one or plural acquired commodity specifying information, and an output unit that outputs the generated two-dimensional code; and
the checkout terminal comprises a second code input unit that reads the outputted two-dimensional code, a two-dimensional code analyzing unit that analyzes the read two-dimensional code so as to acquire the commodity specifying information included in the two-dimensional code, an amount calculating unit that calculates sales proceeds for each purchase and a total amount of all purchases in one transaction by using the commodity specifying information acquired from the two-dimensional code, and a storage unit that stores sales data including the sales proceeds for each purchase in one transaction.

2. The commodity information registration system according to claim 1, wherein the input terminal is put on a position where it cannot be connected to network.

3. The commodity information registration system according to claim 1, wherein the input terminal further comprises a data input unit that inputs a purchase quantity of the same commodity, wherein the two-dimensional code generated by the two-dimensional code generating unit includes the purchase quantity.

4. The commodity information registration system according to claim 1, wherein the bar-code is attached to a purchase, and includes a commodity code for specifying the purchase.

5. The commodity information registration system according to claim 1, wherein the output unit is a print unit that prints the generated two-dimensional code on a predetermined sheet medium.

6. The commodity information registration system according to claim 1, wherein the two-dimensional code includes the commodity specifying information of all purchases in one transaction, and the commodity specifying information included in the two-dimensional code has a commodity code of each commodity, and a purchase quantity of the commodity.

7. The commodity information registration system according to claim 1, wherein the sales data stored in the storage unit includes single-item information composed of a commodity code, a commodity name, a purchase quantity, and sales proceeds, for each purchase.

8. The commodity information registration system according to claim 1, wherein the checkout terminal is connected to a server that manages sales of all commodities through network, and further comprises a communication unit that transmits the sales data of each commodity stored in the storage unit to the server.

9. The commodity information registration system according to claim 1, wherein the checkout terminal comprises:
a weighing unit that measures all purchases in one transaction by weight;
a weight calculating unit that calculates a purchase weight of each purchase from the commodity specifying information acquired from the two-dimensional code and a standard weight of each commodity stored beforehand in the storage unit, so as to calculate the total weight of all purchases in one transaction; and
a weight comparing unit that compares the measured weight and the total weight, and determines that the transaction is fair when the difference between both weights falls within a predetermined weight setting range.
